(19) United States
(12) Patent Application Publication
(10) Pub. No.: US 2007/0278882 A1
(43) Pub. Date: Dec. 6, 2007

(54) MOTOR SHAFT SUPPORTING STRUCTURE FOR REFRIGERATOR

(75) Inventor: Sung Kyoung KIM, Changwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/757,901

(22) Filed: Jun. 4, 2007

(30) Foreign Application Priority Data
Jun. 5, 2006 (KR) 10-2006-0050549

(51) Int. Cl. H02K 5/16

(52) U.S. Cl. 310/90; 417/423.12

(57) ABSTRACT

Provided is a motor shaft supporting structure for reducing noises when a motor operates in a refrigerator. In the motor shaft supporting structure for a refrigerator, a bearing housing supports a motor shaft in an axial direction of the motor shaft. The motor shaft is coupled to a blower fan. A bearing is inserted in the bearing housing for rotatably supporting the motor shaft. An ethylene propylene diene monomer (EPDM) sheet is disposed on a portion of the bearing housing for supporting the motor shaft in the axial direction of the motor shaft.

The present application claims priority under 35 U.S.C. 119 and 35 U.S.C. 365 to Korean Patent Application No. 10-2006-050546 (filed on Jun. 5, 2006), which is hereby incorporated by reference in its entirety.

### BACKGROUND

1. Field

This disclosure relates to a motor shaft supporting structure for a refrigerator.

2. Description of the Related Art

Electric motors are used to convert electric energy into mechanical energy and transmit the mechanical energy to other devices using a motor shaft connected to the device. The electric motors can be classified into direct current (DC) motors and alternating current (AC) motors. Among the AC motors, a shaded pole motor is widely used for applications requiring small torque and installation space.

For example, a refrigerator includes a shaded pole motor for driving a fan to circulate cool air.

Generally, in the shaded pole motor, salient poles are formed by forming grooves in stator poles, and copper rings called shading coils are respectively wound around the salient poles. The shading coils generate a rotating magnetic field, thereby resulting in a torque for rotating a rotator of the shaded pole motor.

The efficiency and power factor of the shaded pole motor are low since currents flow through the shading coils even after the rotor starts to rotate. However, the shaded pole motor requires a small starting torque. Furthermore, the shaded pole motor is simple and robust. Therefore, the shaded pole motor is widely used.

### SUMMARY

Implementations provide a motor shaft supporting structure for reducing noises when a motor operates in a refrigerator.

Implementations also provide a motor shaft supporting structure including an ethylene propylene diene monomer sheet supporting an end of a motor shaft.

The details of one or more implementations are set forth in the accompanying drawings and the description below. Other features will be apparent from the description and drawings, and from the claims.

### BRIEF DESCRIPTION OF THE DRAWINGS

Implementations will become more apparent by the accompanying drawings in which:

FIG. 1 is a view illustrating a shaded pole motor according to an implementation;

FIG. 2 is a perspective view illustrating an assembly of the shaded pole motor and a cooling fan according to an implementation; and

FIG. 3 is a side sectional view illustrating the shaded pole motor according to an implementation.

### DETAILED DESCRIPTION

Reference will now be made in detail to the implementations of the present disclosure, examples of which are illustrated in the accompanying drawings.

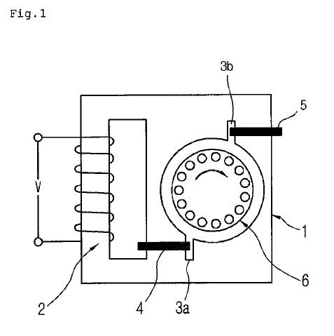

FIG. 1 is a view illustrating a shaded pole motor according to an implementation.

Referring to FIG. 1, the shaded pole motor includes a stator core 1 and a stator coil 2 wound around one side of the stator core 1. Two shaded poles 3a and 3b are formed along an opening of the stator core 1, and shading coils 4 and 5 are wound around the shaded poles 3a and 3b, respectively. A rotor 6 is rotatably inserted into the opening of the stator core 1.

A motor shaft (not shown) is coupled to a center portion of the rotor 6, and both ends of the motor shaft are supported by bearings (not shown) that are fixed to a bearing housing.

A plurality of support sheets is stacked in the bearing housing to reduce noises when the shaded pole motor operates.

When a current is supplied to the stator coil 2, a main magnetic field is generated, and a sub magnetic field is generated by the shaded poles 3a and 3b and the shading coils 4 and 5. Here, the phase of the main magnetic field is different from that of the sub magnetic field. The main magnetic field and the sub magnetic fields form a rotating magnetic field such that the rotor 6 and the motor shaft rotate.

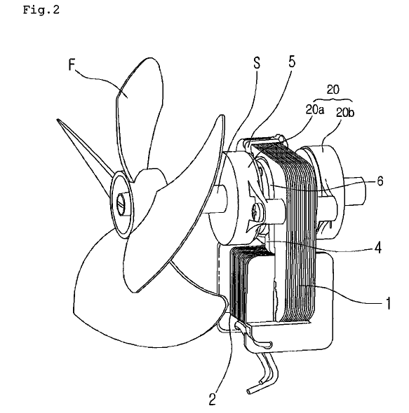

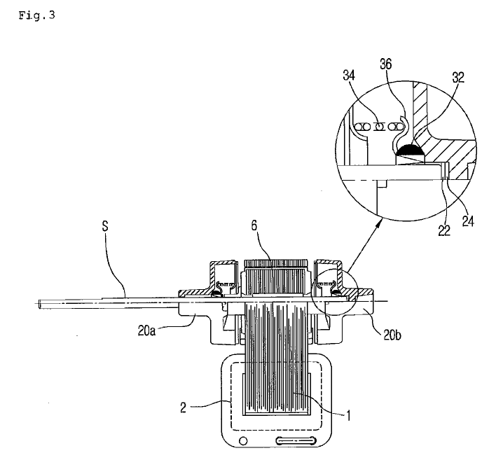

FIG. 2 is a perspective view illustrating an assembly of the shaded pole motor and a cooling fan (F) according to an implementation and FIG. 3 is a side sectional view illustrating the shaded pole motor according to an implementation.

Referring to FIGS. 2 and 3, the cooling fan (F) is coupled to a motor shaft (S) of the shaded pole motor.

One end of the motor shaft (S) is coupled to the cooling fan (F), and the other end of the motor shaft (S) is rotatably inserted in a bearing housing 20. The other end of the motor shaft (S) is axially supported by a plastic sheet 22 and an ethylene propylene diene monomer (EPDM) sheet 24 that are stacked in the bearing housing 20.

In detail, the rotor 6 is rotatably inserted in the opening of the stator core 1 and is coupled with the motor shaft (S).

Front and rear ends of the motor shaft (S) are supported by front and rear bearing housings 20a and 20b of the bearing housing 20 at both sides of the stator core 1. The rear bearing housing 20b is disposed at a backside of the stator core 1 to enclose and support the rear end of the motor shaft (S). A periphery portion of the rear bearing housing 20b is fixed to a back surface of the rear bearing housing 20b using bolts. The front bearing housing 20a disposed at a front side of the stator core 1, and the front end of the motor shaft (S) passes through the front bearing housing 20a. A periphery portion of the front bearing housing 20a is fixed to a front surface of the stator core 1 using bolts.

Bearings 32 are respectively inserted in the front and rear bearing housings 20a and 20b to support the front and rear ends of the motor shaft (S). The bearings 32 contact the front and rear bearing housings 20a and 20b and are supported by springs 34 and spring supports 36.

The front and rear bearing housings 20a and 20b have sloped surfaces at one sides that are spaced away from the stator core 1, such that the sloped surfaces can make contact with side surfaces and portions of top surfaces of the bearings 32. Furthermore, lower portions of the spring supports 36 are gradually curved such that the lower ends of the spring supports 36 can make contact with the other side surfaces and portions of the top surfaces of the bearings 32. Therefore, the bearing 32 can be stably restricted in a radial direction of the motor shaft (S).

In addition, upper portions of the spring supports 36 are gradually curved in an opposite direction to the curvature of the lower portions of the spring supports 36, such that the springs 34 can be stably supported by the spring supports 36. Furthermore, the front and rear bearing housings 20a and 20b have gradually curved surfaces at the other sides that are close to the stator core 1, such that the springing 34 can be stably supported.

The plastic sheet 22 and the EPDM sheet 24 are stacked in the rear bearing housing 20b.

The plastic sheet 22 has a high abrasion resistance such that the plastic sheet 22 does not easily wear even when the motor shaft (S) rotates against the plastic sheet 22. Although the EPDM sheet 24 may have an abrasion resistance lower than that of the plastic sheet 22, the EPDM sheet 24 is suitable for reducing vibrations transmitted from the motor shaft (S). Furthermore, the EPDM sheet 24 can be elastic even at a low temperature, such that the anti-vibration characteristics of the EPDM sheet 24 can be maintained.

The EPDM sheet 24 is formed of EPDM. The EPDM is amorphous and formed by copolymerization using ethylene and propylene. The EPDM has intermediate physical characteristics between those of natural rubber and stylene-butadiene rubber (SBR). The EPDM is similar to sponge. The physical characteristics of the EPDM are constant in the temperature range of −55° C. to 150° C., such that the EPDM can be used at a low temperature.

When a current is supplied to the stator coil 2, a main magnetic field is generated by the stator coil 1 and the stator coil 2, and at the same time, a sub magnetic field having a different phase from that of the main magnetic field is generated by the shaded poles 3a and 3b and the shading coils 4 and 5. The main and sub magnetic fields are combined into a rotating magnetic field, and the rotor 6 is rotated by the rotating magnetic field. As a result, the motor shaft (S) coupled to the rotor 6, and the cooling fan (F) coupled to the motor shaft (S) are rotated.

Although the cooling fan (F) and the motor shaft (S) vibrate, the vibration is not transmitted to other components of a refrigerator owing to the plastic sheet 22 and the EPDM sheet 24. For the same reason, noises can be reduced.

When the shaded pole motor and the cooling fan (F) are installed in a cooling air passage of a refrigerator, the shaded pole motor and the cooling fan (F) may operate at a temperature lower than 5° C. However, the physical characteristics of the plastic sheet 22 and the EPDM sheet 24 are not changed at a low temperature, such that transmission of vibration can be effectively prevented even at a low temperature. Furthermore, a resonance vibration can be prevented owing to the plastic sheet 22 and the EPDM sheet 24.

The above-described implementations discuss a shaded motor for a refrigerator. However, the present disclosure is not limited to the shaded motor.

Although implementations have been described with reference to a number of illustrative implementations thereof, it should be understood that numerous other modifications and implementations can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A motor shaft supporting structure for a refrigerator, comprising:
a bearing housing supporting a motor shaft in an axial direction of the motor shaft, the motor shaft being coupled to a blower fan;
a bearing inserted in the bearing housing and rotatably supporting the motor shaft; and
an ethylene propylene diene monomer (EPDM) sheet disposed on a portion of the bearing housing for supporting the motor shaft in the axial direction of the motor shaft.

2. The motor shaft supporting structure according to claim 1, further comprising a plastic sheet for supporting the motor shaft, the plastic sheet and the ethylene propylene diene monomer (EPDM) being stacked on the bearing housing.

3. The motor shaft supporting structure according to claim 2, wherein the plastic sheet contacts the motor shaft.
